(19) United States
(12) Patent Application Publication
(10) Pub. No.: US 2009/0164373 A1
(43) Pub. Date: Jun. 25, 2009

(54) System and Method of Preventing Password Theft

(75) Inventor: Simon Blythe, Ely (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/962,729

(22) Filed: Dec. 21, 2007

(51) Int. Cl. G06Q 40/00

(52) U.S. Cl. 705/44

(57) ABSTRACT

A method and system for securely accessing an account using a security device that includes: (1) receiving a request via a payment device for access to an account having account information, wherein the request includes an account number; (2) generating randomly a numeric value; (3) displaying the numeric value; (4) prompting data entry of a combined PIN via the payment device, wherein the combined PIN is a combination of the numeric value and the PIN; (5) uncombining the numeric value from the entered combined PIN to provide an uncombined PIN; (6) comparing the uncombined PIN to the PIN; and (7) permitting access to the account information based on the comparison.

### FIELD OF THE INVENTION

The present invention relates generally to secure electronic transactions using credit cards, and more particularly relates to systems and methods for increasing the security when a personal identification number (“PIN”) or unique challenge question is used for verification of the identity of the cardholder.

### BACKGROUND OF INVENTION

Credit card “skimming” is a form of fraud that hurts consumers, wreaks havoc with merchants and costs the industry millions of dollars every year. Skimming fraud takes many forms, but most often involves a cardholder turning over physical possession of his or her card to a retail or restaurant employee, who then swipes the card through a small, illegal card reader called a “skimmer.” The skimmer copies the data encoded on the card's magnetic stripe. This information is then used to manufacture counterfeit cards that are used to make illegal charges against the account. Most skimming occurs in restaurants where the waiter or waitress takes the card and the bill from the cardholder for payment. It takes only a few seconds to run the card through a “skimmer” that captures the credit card number, personal identification and any other information that is located on the magnetic stripe. A more sophisticated form of skimming involves implanting sophisticated skimmer “bugs” into card payment terminals, which are not equipped to detect this type of attack. These devices read the information from cards that are swiped in the terminal's card reader and either store the information until retrieved by the thief or transmit the information using a radio transmitter.

In electronic funds transfer applications, it is customary to authenticate the originator of the transaction by use of a secret code, which is known to the originator of the transaction and is in some way verifiable by electronic equipment under control of the institution that controls the funds. This secret code is usually referred to as a “personal identification number” (PIN) or a password. For purposes of this patent application, these secret authentication codes are referred to collectively as a “PIN.” A PIN is a secret numeric password shared between a user and a system that can be used to authenticate the user to the system. Typically, the user is required to provide a non-confidential user identifier (“ID”) or token (such as a credit card or banking card) and a confidential PIN to gain access to the system. Upon receiving the user ID and PIN, the system looks up the PIN based upon the user ID and compares the looked-up PIN with the received PIN. The user is granted access only when the number entered matches with the number stored in the system.

Financial PINs are often 4-digit numbers in the range 0000-9999, resulting in 10,000 possible numbers. Many PIN verification systems allow three attempts, thereby giving a card thief a 1/3333 chance to guess the correct PIN before the card is blocked from accessing the account. This is true only if all PINs are equally likely and the attacker has no further information available, which has not been the case with some of the many PIN generation and verification algorithms that banks and ATM manufacturers have used in the past. These systems often use numbers that are more easily remembered by the user more frequently and, thus, make it easier for a thief to identify the PIN.

In addition to obtaining the information contained on the magnetic stripes of credit card, thieves often obtain PINs by watching cardholders as they enter their PINs at publicly accessible terminals such as ATMs. A thief may simply stand in line and look over the cardholder's shoulder as he enters his PIN or the thief may set up a hidden camera that records entries to a keyboard on a terminal. In either case, the thief obtains the PIN and together with the information from the magnetic stripe is able to access accounts and make unauthorized transactions. Typically, the PIN does not change until the customer requests the card issuer for a new PIN or unauthorized activity in the account is reported.

In general, to process payment information over a network, a PIN can be used to verify that the sender of payment information is the person or entity authorized to use the payment information. For example, if a customer is using a debit card or other electronic account access to purchase goods and services on the Internet, the payment information will include a PIN which will be checked by the credit card issuer processing center. While using a credit card over a network currently does not typically involve the use of a PIN, the verification technique of a PIN could be used with credit cards or electronic cash cards. If the PIN is valid, the transaction will proceed pending other verifications. If the PIN is invalid, the customer will be asked to retransmit the payment information with the correct PIN. If the correct PIN is not entered after a predetermined number of times, the transaction will be denied.

The PIN prevents the unauthorized use of a credit card or account information in the case of a lost or stolen card. However, this information can be stolen and is especially susceptible to interception and misuse by unauthorized third parties when transmitted over an open network such as the Internet. Accordingly, PIN information must be protected in typical credit and debit transactions, automatic teller machine (“ATM”) transactions and any transaction over a network, which includes transmitting electronic transaction information such as account numbers. Therefore, if the payment information is being transmitted over an open network such as the Internet, it must be sent in a secure manner. When the PIN information is being sent to a merchant for processing, the merchant must be able to know the PIN is valid without actually being able to obtain or view the PIN information. Otherwise, fraudulent use of a customer's PIN by unscrupulous merchants or employees may result.

In order to increase security for credit cards and other similar devices and to provide cardholders with additional functions, “smart cards” have come into wide use. In general, a smart card (also referred to as chip cards or integrated circuit cards (ICC)) is a credit card with embedded integrated circuits which can process information, i.e., it can receive input which is processed—by way of the ICC applications—and delivered as an output. The smart cards can be either memory cards, which contain only non-volatile memory storage components, and perhaps some specific security logic, or microprocessor cards, which contain volatile memory and microprocessor components. The microprocessor on the smart card provides security by allowing the host computer and card reader to actually “talk” to the microprocessor. The applications of smart cards include their use as credit or ATM cards, in a fuel card, SIMs for mobile phones, authorization cards for pay television, pre-pay utilities in household, high-security identification and access-control cards, and public transport and public phone payment cards.

In some more sophisticated forms of credit card fraud, the terminal is compromised and the thief uses electronic devices to capture the magnetic stripe data and also the key pad entry of a user's PIN. This provides the thief with enough information to clone the user's card and access the user's account from a terminal. Therefore, there is a need for a security system that makes it more difficult to access an account under these circumstances. More specifically, there is a need for a system that does not use the same PIN each time an account is accessed.

The PIN methods used for verifying authorized users have not reduced card fraud to acceptable levels and so there is a need for a PIN method that will provide increased security against thieves. Moreover, there is a need for a PIN method that incorporates the functionality of a smart card to provide a higher level of security.

### SUMMARY OF THE INVENTION

In accordance with the present invention, a method and system for securely accessing an account using a security device such as a credit card and a unique challenge such as a PIN are provided. In one embodiment, the method includes: (1) receiving a request via a payment device for access to an account having account information, wherein the request includes an account number; (2) generating randomly a numeric value; (3) displaying the numeric value; (4) prompting data entry of a combined PIN via the payment device, wherein the combined PIN is a combination of the numeric value and the PIN; (5) uncombining the numeric value from the entered combined PIN to provide an uncombined PIN; (6) comparing the uncombined PIN to the PIN; and (7) permitting access to the account information based on the comparison. The method can also include conducting a financial transaction after access to the account is permitted.

The method can also include displaying the randomly generated numeric value via the payment device before prompting data entry of the combined PIN. In a preferred embodiment, the method includes blocking access to the account information when the uncombined PIN and the PIN are compared one or more times and are not the same. The combining can be adding the numeric value to the PIN or subtracting the numeric value from the PIN. The request for access to the account can be made using a security device and the security device can include a magnetic stripe or a microprocessor chip for storing the account number. Preferably, the security device is a credit card, a debit card or a bank card.

Another embodiment of the invention is a system for securely accessing an account using a payment device. The system includes a security device and a payment device. The security device includes a magnetic stripe that has account information, which includes an account number. The payment device includes: a security device reader for reading the account information from the magnetic stripe; first software for receiving a request to access the account and generating randomly a numeric value; a display for displaying the numeric value and prompting data entry of a combined PIN, wherein the combined PIN is a combination of the numeric value and the PIN; a data entry device for entering the combined PIN; and second software for uncombining the numeric value from the entered combined PIN to provide an uncombined PIN, comparing the uncombined PIN to the PIN and permitting access to the account information based on the comparison.

The data entry device for the system n be a keyboard, a key pad, a touch screen, a joy stick a trackball or a mouse. The security device can be a credit card, a debit card or a bank card. The system can also include third software for blocking access to the account information when the uncombined PIN and the PIN are compared one or more times and are not the same.

In another embodiment, the method for securely accessing an account using a payment device includes: receiving a request via a payment device for access to an account having account information, wherein the request includes an account number; reading a plurality of challenges and a plurality of unique responses corresponding to the plurality of challenges from a security device; prompting data entry of a unique response to one of the plurality of challenges; comparing the entered unique response to the plurality of unique responses; and permitting access to the account information based on the comparison. The method can also include conducting a financial transaction after access to the account is permitted.

The request for access to the account can be made using a security device and the security device can include a magnetic stripe or a microprocessor chip for storing the account number. Preferably, the security device is a credit card, a debit card or a bank card. The method can also include blocking access to the account information when the entered unique response and the plurality of unique responses are compared one or more times and are not the same.

A further embodiment of the invention is a system for securely accessing an account using a payment device. The system includes a security device and a payment device. The security device includes: a magnetic stripe or a microprocessor that includes account information, wherein the account information includes an account number, a plurality of challenges and a plurality of unique responses corresponding to the plurality of challenges. The payment device includes: a credit card reader for reading the account information in the microprocessor; first software for receiving a request for access to the account and the account information read from the microprocessor and selecting a challenge from the plurality of challenges; a display for prompting data entry of a unique response to one of the plurality of challenges; a data entry device for entering the unique response; and second software for comparing the entered unique response to the plurality of unique responses and permitting access to the account information based on the comparison.

The microprocessor can have data storage, data processing capabilities or data storage and data processing capabilities. The data entry device is preferably a keyboard, a key pad, a touch screen, a joy stick a trackball or a mouse. The security device can be a credit card, a debit card or a bank card. The system can also include third software for blocking access to the account information when the entered unique response and the plurality of unique responses are compared one or more times and are not the same.

### BRIEF DESCRIPTION OF THE FIGURES

The preferred embodiments of the method for providing secure credit card transactions of the present invention, as well as other objects, features and advantages of this invention, will be apparent from the accompanying drawings wherein:

FIG. 1 is a flow chart showing the first embodiment of the present invention which uses a PIN plus an integer.

FIG. 2 is a flow chart showing the second embodiment of the present invention which uses a microprocessor chip containing unique challenges and responses for the cardholder.

### DETAILED DESCRIPTION OF THE INVENTION

The present invention is a method for reducing credit card fraud from PIN theft by requiring the credit card user (also referred to herein as “the cardholder”) to enter more than the PIN to access account information. In one embodiment, the payment device changes the PIN each time the cardholder accesses the account. In a second embodiment, the processing capacities of the existing chips on credit cards, debit cards, check cashing cards and other mobile payment devices are used to provide additional security before access is allowed.

For the purposes of the present disclosure, the term “credit cards” is used generically to refer to all of the different types of smart cards and cards with magnetic stripes that can be validated using a PIN or password, without regard to the intended use or function of the card. The methods disclosed herein can be used for any type of security card and the use of the term credit card is not intended to limit the scope of the invention in any manner.

Credit card accounts and other types of secured financial accounts can typically be accessed using a payment device on the premises of the financial institution or at a remote location. The credit card is either swiped or inserted into a card reader that retrieves information stored on a magnetic stripe or in a microprocessor chip. The magnetic stripe or “magstripe” stores data by modifying the magnetism of tiny iron-based magnetic particles on a band of magnetic material on the card. The magnetic stripe is read by physical contact and swiping past the head of the card reader. The microprocessor chip also stores information on the card and the information is accessed by a reader that provides energy to power the chip. After the payment device reads the account number of the credit card, the user must enter a password or PIN.

As used herein, the term “payment device” refers to an automated system for providing remote access to private account information, e.g., credit card accounts or bank accounts. The system typically includes at least a display screen, a keypad or keyboard and a computer that provides connectivity to a network that includes a database containing customer account information. For the purposes of the present disclosure, the term “terminal” is used interchangeably with the term payment device.

In one embodiment, the payment device computer includes software that performs a variety of functions including: receiving the request to access the account and randomly generating a numeric value; uncombining the numeric value from the entered combined PIN to provide an uncombined PIN; comparing the uncombined PIN to the PIN and permitting access to the account information based on the comparison; and blocking access to the account information when the uncombined PIN and the PIN are compared one or more times and are not the same.

In another embodiment, the payment device computer includes software that: receives the request for access to the account and the account information read from the microprocessor; selects a challenge from the plurality of challenges; compares the entered unique response to the plurality of unique responses and permits access to the account information based on the comparison; and blocks access to the account information when the entered unique response and the plurality of unique responses are compared one or more times and are not the same. The programming of the computer with the software required to perform these functions is not disclosed in detail since programming such software is well within the knowledge of one of ordinary skill in the art.

Credit cards are commonly used together with a PIN for authenticating the identity of the cardholder. In addition to the traditional PIN, the present invention increases the security by requiring the cardholder to either change the PIN by a numerical value randomly generated by the payment device or enter additional information in the form of responses to challenges displayed on the payment device. The challenges are preferably in the form of queries relating to personal user information that is provided to the payment device by the microprocessor on the card. The additional information entered by the cardholder to access the account is referred to herein as the “combined PIN,” the “PIN plus” or the “PIN+” information. The PIN+ changes each time the account is accessed to make it more difficult for a thief or unauthorized user to access an account with a stolen PIN.

In a first embodiment of the present invention referred to herein as the “PIN offset” method, the cardholder changes or “offsets” the PIN by adding or subtracting a different value or integer to the PIN each time the credit card is used. For example, when the cardholder uses a payment device such as an ATM terminal, the terminal randomly generates an integer (“N”), which can be a simple number (“N”) such as 1, 10, 100 or 1000, and instructs the user to add or subtract N from the account PIN. The cardholder adds or subtracts N to the PIN to create the combined PIN or PIN offset (“PIN±N”) and enters it via the terminal. The terminal then subtracts N from the entered PIN±N to provide an “uncombined PIN” before passing it on for verification. In a preferred embodiment, the card has a microprocessor chip that is programmed for computing the offset and the chip subtracts or adds N from the PIN±N entered by the user and sends the computed or uncombined PIN value for verification without further terminal intervention.

The PIN offset method uses a credit card with a magnetic stripe that contains a unique account number and account information. A PIN is assigned to the unique account number. When the cardholder uses a payment device (such as an ATM terminal) to access the account, the card is swiped or inserted into a card reader and the unique account number is used by the payment device to identify the cardholder. The payment device then randomly generates an integer (“N”) and displays a message directing the user to either add or subtract N from the PIN and enter the combined or calculated value (PIN±N) via the payment device. The payment device then performs the reverse operation on the entered value (i.e., if the user added N, the payment device subtracts N and if the user subtracted N, the payment device adds N) to arrive at the user's PIN, which is verified by the payment device using standard methods for PIN verification. After the PIN is verified, the user can access the account information and conduct financial transactions.

The next time the cardholder attempts to access the account information, a different integer (N) is displayed on the payment device, which results in a different PIN±N. Thus, if the PIN±N entered by the cardholder is stolen by a thief, the thief would only have the single use PIN±N and not the cardholder's actual PIN. Since the PIN±N changes each time the account is accessed, the stolen PIN±N cannot be used by the thief and it is highly unlikely that a thief would be able to guess the PIN from the stolen data.

In a second embodiment of the present invention referred to herein as the “chip and PIN” method, the credit card has an embedded microprocessor chip that has processing capabilities and stored data that can be read by the payment device. The stored data includes a plurality of challenges and a plurality of unique responses corresponding to the plurality of challenges that are provided by the cardholder. Preferably, the challenges and responses relate to either the cardholder's PIN or personal information such as a memorable date, a pet's name or a favorite color. The information entered by the cardholder is processed by the microprocessor and then submitted through a card reading device to a host computer which verifies/authenticates the cardholder information.

When the user inserts the card into the reader, the payment device reads the information on the card's microprocessor chip including the unique account number and the plurality of challenges and unique responses. The payment device issues a challenge chosen at random from the list of challenges read off the chip. The cardholder can directly enter the response if the payment device has an alphanumeric keyboard or choose a response from an on-screen list with an associated numerical value (e.g., red=1472, green=5456, etc.). The payment device then compares the cardholder's response with the response stored in the card's microprocessor chip. If the correct response was entered, the cardholder is allowed access to the account information. If the card is skimmed or lost, there is only a small chance that the thieves will know the answer to the next PIN challenge.

One of the advantages of this method is that the secure information on the microprocessor cannot be easily stolen by a thief. Even when the credit card is given to a server at a restaurant and is removed from the owner's presence, the information can only be downloaded using a card reader. Moreover, once the thief has downloaded the program on the microprocessor, he still needs the correct response to the challenge query to access the account. Another advantage of the method is that the microprocessor on the card can be programmed for the challenge query to change each time the card is used. Therefore, even if a thief skims the response to a challenge query when the card owner uses an unsecured location, such as an ATM, the information is of no use because a different challenge query is presented and the response is different the next time the credit card is used.

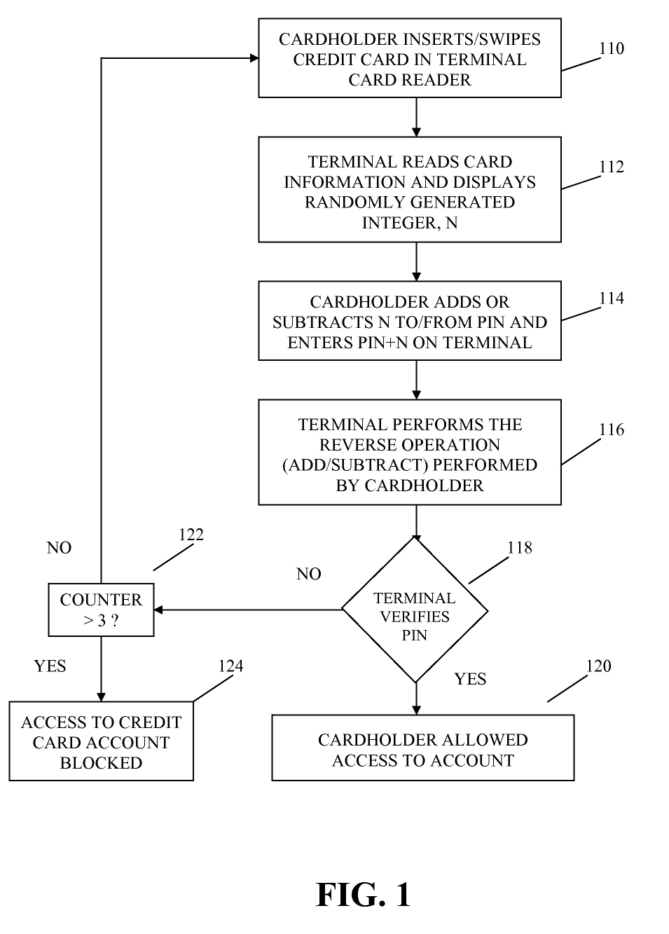

Referring now to the drawings, FIG. 1 is a flow chart for the PIN plus an integer method. In step 110, a cardholder inserts or swipes a credit card in a terminal card reader. The terminal reads the card information and displays a randomly generated integer, N, in step 112. The cardholder reads the displayed integer, N, and in step 114 the cardholder either adds or subtracts N to/from the PIN for the account and enters PIN+N on the terminal, preferably using a keyboard. In step 116, the terminal performs the reverse operation (i.e., adds or subtracts) of the operation performed by the cardholder to provide a calculated PIN and in step 118, the terminal verifies that the calculated PIN is the correct PIN for the account.

If the terminal determines that the PIN has been correctly entered, the cardholder is allowed access to the account in step 120. If the terminal determines that the correct PIN has not been entered, a counter determines in step 122 how many times the incorrect PIN is entered. If the incorrect PIN was entered fewer than three times, the cardholder is allowed another opportunity to access the account by repeating the steps starting with step 110. If the incorrect PIN is entered more than three times, the terminal blocks access to the credit card account in step 124.

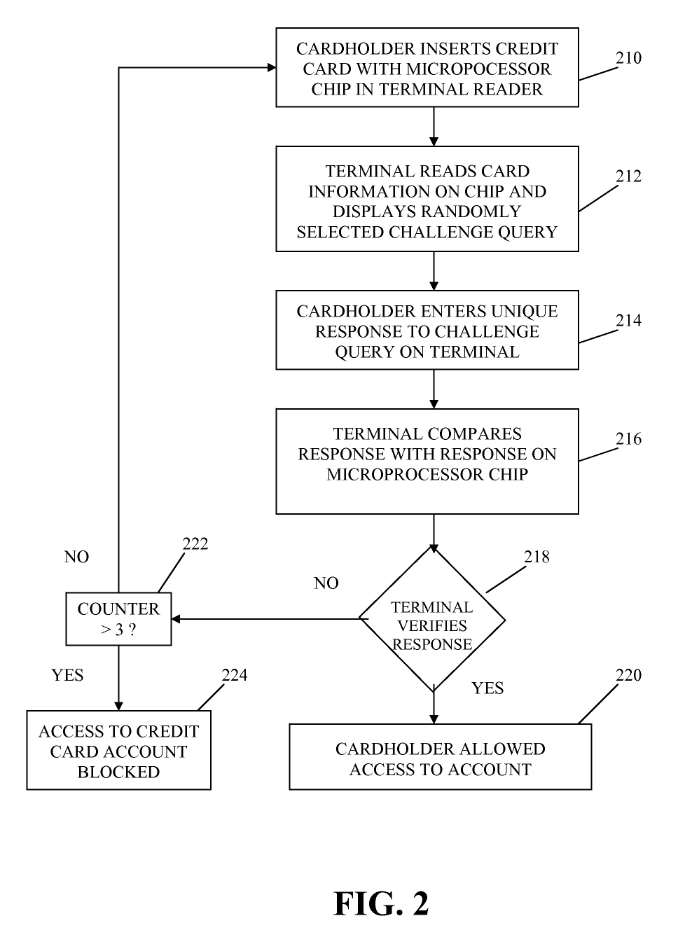

FIG. 2 is a flow chart for the microprocessor chip or PIN plus chip method. In step 210, a cardholder inserts a credit card in a terminal card reader. The terminal reads the card information, which includes a plurality of unique challenge queries and responses, and displays a randomly selected challenge query in step 212. The cardholder enters a response to the challenge query on the terminal in step 214. These responses are preferably entered using a keyboard or key pad. In step 216, the terminal compares the response entered by the cardholder with the response stored on the microprocessor chip. In step 218, the terminal verifies that the entered response is correct.

If the terminal determines that the cardholder has entered the correct response, the cardholder is allowed access to the account in step 220. If the terminal determines that the correct response has not been entered, a counter determines in step 222 how many times an incorrect response was entered. If an incorrect response is entered fewer than three times, the cardholder is allowed another opportunity to access the account by repeating the steps starting with step 210. If an incorrect response is entered more than three times, the terminal blocks access to the credit card account in step 224.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A method for securely accessing an account using a payment device comprising:
receiving a request via a payment device for access to an account having account information, wherein the request comprises an account number;
generating randomly a numeric value;
displaying the numeric value;
prompting data entry of a combined PIN via the payment device, wherein the combined PIN is a combination of the numeric value and the PIN;
uncombining the numeric value from the entered combined PIN to provide an uncombined PIN;
comparing the uncombined PIN to the PIN; and
permitting access to the account information based on the comparison.

2. The method for securely accessing an account using a payment device according to claim 1 further comprising conducting a financial transaction.

3. The method for securely accessing an account using a payment device according to claim 1, wherein the combining comprises adding the numeric value to the PIN or subtracting the numeric value from the PIN.

4. The method for securely accessing an account using a payment device according to claim 1, wherein the request for access to the account is made using a security device and wherein the security device comprises a magnetic stripe or a microprocessor chip for storing the account number.

5. The method for securely accessing an account using a payment device according to claim 4, wherein the security device is a credit card, a debit card or a bank card.

6. The method for securely accessing an account using a payment device according to claim 1 further comprising displaying the randomly generated numeric value via the payment device before prompting data entry of the combined PIN.

7. The method for securely accessing an account using a payment device according to claim 1 further comprising blocking access to the account information when the uncombined PIN and the PIN are compared one or more times and are not the same.

8. A system for securely accessing an account using a payment device comprising:
a security device comprising:
a magnetic stripe comprising account information, wherein the account information comprises an account number; and
a payment device comprising:
a security device reader for reading the account information from the magnetic stripe;
first software for receiving a request to access the account and generating randomly a numeric value;
a display for displaying the numeric value and prompting data entry of a combined PIN, wherein the combined PIN is a combination of the numeric value and the PIN;
a data entry device for entering the combined PIN; and
second software for uncombining the numeric value from the entered combined PIN to provide an uncombined PIN, comparing the uncombined PIN to the PIN and permitting access to the account information based on the comparison.

9. The system for securely accessing an account using a payment device according to claim 8, wherein the data entry device is a keyboard, a key pad, a touch screen, a joy stick a trackball or a mouse.

10. The system for securely accessing an account using a payment device according to claim 8, wherein the security device is a credit card, a debit card or a bank card.

11. The system for securely accessing an account using a payment device according to claim 8 further comprising third software for blocking access to the account information when the uncombined PIN and the PIN are compared one or more times and are not the same.

12. A method for securely accessing an account using a payment device comprising:
receiving a request via a payment device for access to an account having account information, wherein the request comprises an account number;
reading a plurality of challenges and a plurality of unique responses corresponding to the plurality of challenges from a security device;
prompting data entry of a unique response to one of the plurality of challenges;
comparing the entered unique response to the plurality of unique responses; and
permitting access to the account information based on the comparison.

13. The method for securely accessing an account using a payment device according to claim 12 further comprising conducting a financial transaction.

14. The method for securely accessing an account using a payment device according to claim 12, wherein the request for access to the account is made using a security device and wherein the security device comprises a magnetic stripe or a microprocessor chip for storing the account number.

15. The method for securely accessing an account using a payment device according to claim 14, wherein the security device is a credit card, a debit card or a bank card.

16. The method for securely accessing an account using a payment device according to claim 13 further comprising blocking access to the account information when the entered unique response and the plurality of unique responses are compared one or more times and are not the same.

17. A system for securely accessing an account using a payment device comprising:
a security device comprising:
a magnetic stripe or a microprocessor comprising account information, wherein the account information comprises an account number, a plurality of challenges and a plurality of unique responses corresponding to the plurality of challenges; and
a payment device comprising:
a credit card reader for reading the account information in the microprocessor;
first software for receiving a request for access to the account and the account information read from the microprocessor and selecting a challenge from the plurality of challenges;
a display for prompting data entry of a unique response to one of the plurality of challenges;
a data entry device for entering the unique response; and
second software for comparing the entered unique response to the plurality of unique responses and permitting access to the account information based on the comparison.

18. The system for conducting a secure financial transaction according to claim 17, wherein the microprocessor comprises data storage, data processing capabilities or data storage and data processing capabilities.

19. The system for conducting a secure financial transaction according to claim 17, wherein the data entry device is a keyboard, a key pad, a touch screen, a joy stick a trackball or a mouse.

20. The system for conducting a secure financial transaction according to claim 17, wherein the security device is a credit card, a debit card or a bank card.

21. The system for conducting a secure financial transaction according to claim 17 further comprising third software for blocking access to the account information when the entered unique response and the plurality of unique responses are compared one or more times and are not the same.
